(19) United States
(12) Patent Application Publication
(10) Pub. No.: US 2009/0320088 A1
(43) Pub. Date: Dec. 24, 2009

(54) Access enforcer

(76) Inventors: Jasvir Singh Gill, Fremont, CA (US); Ravinder Gill, Fremont, CA (US); Prasada Rao Pysla, Fremont, CA (US); Sandeep K. Malik, Fremont, CA (US); Srinivasa Kakkera, Newark, CA (US)

Correspondence Address: SCHWEGMAN, LUNDBERG & WOESSNER/SAP, P.O. BOX 2938, MINNEAPOLIS, MN, 55402, US

(21) Appl. No.: 11/918,620

(22) PCT Filed: Mar. 30, 2006
(86) PCT No.: PCT/US2006/012055

§ 371 Date: May 27, 2009

Related U.S. Application Data
(60) Provisional application No. 60/683,928, filed on May 23, 2005.

(51) Int. Cl. G06F 9/46; G06F 15/16; G06F 9/00; G06F 21/00

(52) U.S. Cl. 726/1; 718/102; 709/206; 713/100

(57) ABSTRACT

A computer-driven resource manager (122) selectively executes user-initiated tasks (113) according to established rules (112) defining users' permissions for such tasks. A workflow engine (116) manages redefinition of the rules. Responsive to receiving (602) a request to change the rules, the engine processes the request (600). This includes reviewing the request and selecting (604) a corresponding approval path. Also, the workflow engine sequentially proceeds (610, 612, 614, 616, 620) through a sequence of stages defined by the selected path, where in each stage the workflow engine electronically solicits approvals from one or more approvers indicated by the selected approval path. The engine continues through the stages until receiving at least one denial, or all required approvals (616). Responsive to receiving all required approvals, an electronic message is transmitted (618) directing amendment of the rules per the user request.

### CROSS-REFERENCE TO RELATED APPLICATIONS

This application claims the benefit of the following earlier-filed U.S. Provisional Application in accordance 35 USC 119: Application No. 60/683,928, filed on May 23, 2005. The entirety of the foregoing application is hereby incorporated herein by reference.

### BACKGROUND OF THE INVENTION

1. Field of the Invention

The present invention relates to computer-driven enterprise resource planning (ERP) systems that use a set of rules to regulate users' activities in the ERP system. More particularly, the invention concerns various computer-implemented methods and devices to manage redefinition of those rules.

2. Description of the Related Art

ERP systems are management information systems that integrate, automate, track, and regulate many business practices of a company. ERP systems can address many facets of a company's operation, such as accounting, sales, invoicing, manufacturing, logistics, distribution, inventory management, production, shipping, quality control, information technology, and human resources management. ERP systems can include computer security to protect against both outside crime such as industrial espionage, as well as and inside crime such as embezzlement. ERP systems can be set up to detect, prevent, and report a variety of different occurrences of fraud, error, or abuse.

Among other areas of focus, ERP systems can address how the company interacts with customers (“front end” activities), quality control and other internal workings of the company (“back end” activities), and interactions with suppliers and transportation providers (“supply chain”).

It is becoming increasingly beneficial for companies to use ERP systems in view of recent laws such as “The Sarbanes-Oxley Act of 2002” (Pub. L. No. 107-204, 116 Stat. 745, Jul. 30, 2002), also known by other names such as “Sarbanes-Oxley,” the “Public Company Accounting Reform and Investor Protection Act of 2002,” and “SOX.” Sarbanes-Oxley seeks to protect investors by improving the accuracy and reliability of corporate disclosures. The Act covers issues such as establishing a public company accounting oversight board, auditor independence, corporate responsibility, and enhanced financial disclosure.

Among other things, SOX requires CEOs and CFOs to certify financial reports. Moreover, SOX mandates a set of internal procedures designed to ensure accurate financial disclosure.

Although modern ERP systems help companies become better organized and address the challenges of regulatory requirements such as Sarbanes-Oxley, administering an ERP system can be exceedingly complex. Indeed, because of their wide scope of application within a company, ERP software systems employ some of the largest bodies of software ever written.

ERP systems utilize a complex framework of rules to regulate and track employee activities. Setting up these rules, then, is a separate matter completely, aside from the design and operation of such a system. Requiring laborious action at the hands of system administrators, the process of configuring and updating an ERP system can be complicated, time consuming, expensive, and error prone. Moreover, if a company falls behind in configuring their ERP system, the operation of the ERP system can be error prone, labor intensive, or merely ineffective.

### SUMMARY OF THE INVENTION

Broadly, a computer-driven resource manager selectively executes user-initiated tasks according to established rules defining users' permissions for such tasks. A workflow engine manages redefinition of the rules. Responsive to receiving a request to change the rules, the engine processes the request. This includes reviewing the request and selecting a corresponding approval path. Also, the workflow engine sequentially proceeds through a sequence of stages defined by the selected path, where in each stage the workflow engine electronically solicits approvals from one or more approvers indicated by the selected approval path. The engine continues through the stages until receiving at least one denial, or all required approvals. Responsive to receiving all required approvals, an electronic message is transmitted directing amendment of the rules per the user request.

The teachings of this disclosure may be implemented as a method, apparatus, logic circuit, signal bearing medium, or a combination of these. This disclosure provides a number of other advantages and benefits, which should be apparent from the following description.

### BRIEF DESCRIPTION OF THE DRAWINGS

FIG. 1A is a block diagram of the hardware components and interconnections of a multi-user shared resource computing system.

FIG. 1B is a block diagram of several exemplary workflows.

FIG. 1C is a block diagram of several on-the-fly workflow changes.

FIG. 2 is a block diagram of a digital data processing machine.

FIG. 3 shows an exemplary signal-bearing medium.

FIG. 4 is a perspective view of exemplary logic circuitry.

FIG. 5 is a flowchart of exemplary operations preparatory to FIG. 6.

FIG. 6 is a flowchart of exemplary operations to manage redefinition of software rules that regulate users' activities conducted in a shared computing resource.

FIG. 7 is a flowchart of exemplary follow-up operations to FIG. 6.

FIG. 8 is a flowchart of an exemplary approver subsequence.

FIGS. 9-11 show some exemplary screen shots.

### DETAILED DESCRIPTION

The nature, objectives, and advantages of the invention will become more apparent to those skilled in the art after considering the following detailed description in connection with the accompanying drawings.

### Hardware Components & Interconnections

### Overall Structure

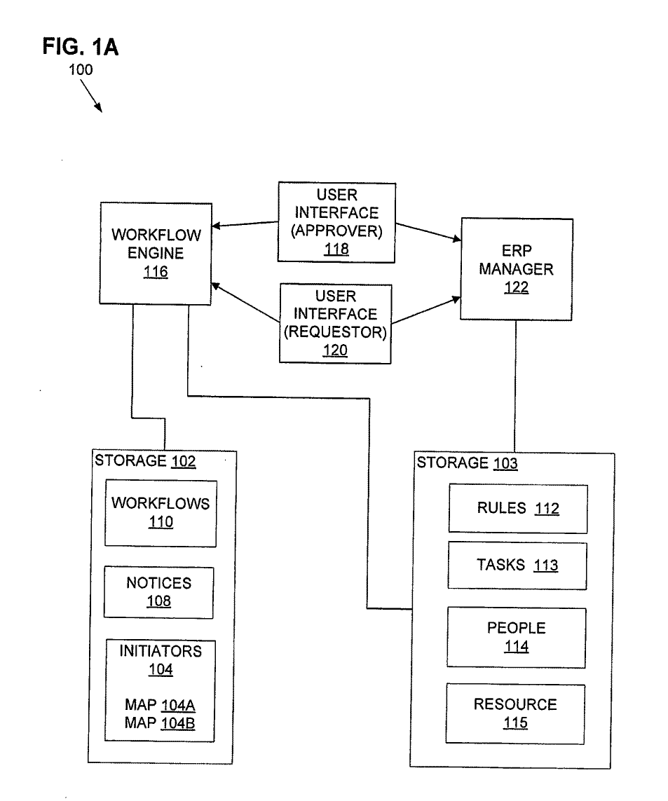

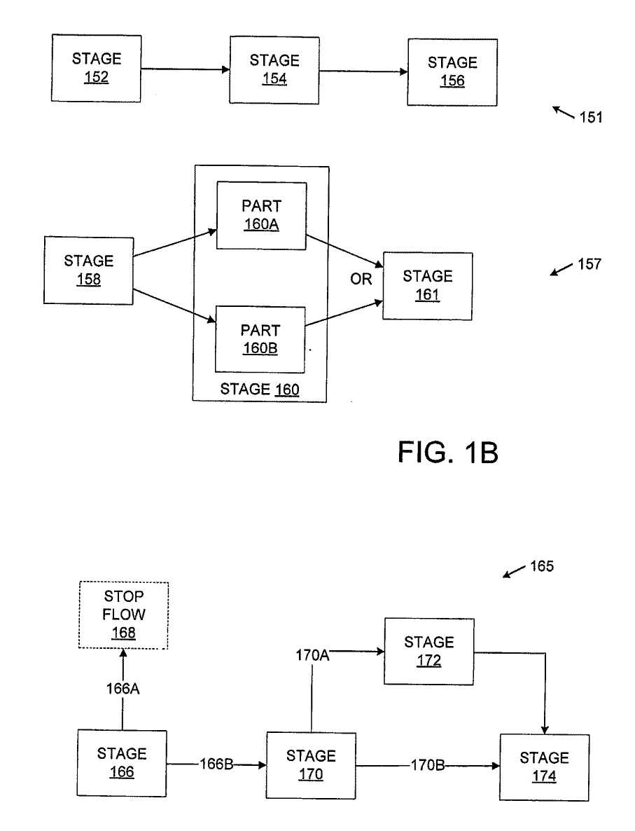

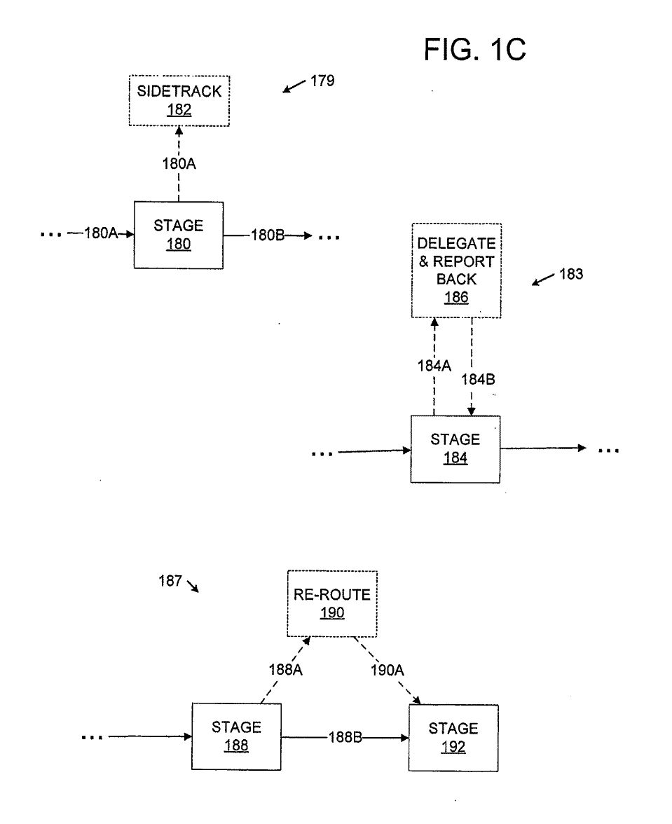

One aspect of this disclosure is a multi-user shared resource computing system, which may be embodied by various hardware components and interconnections. One example is the system 100 of FIG. 1A.

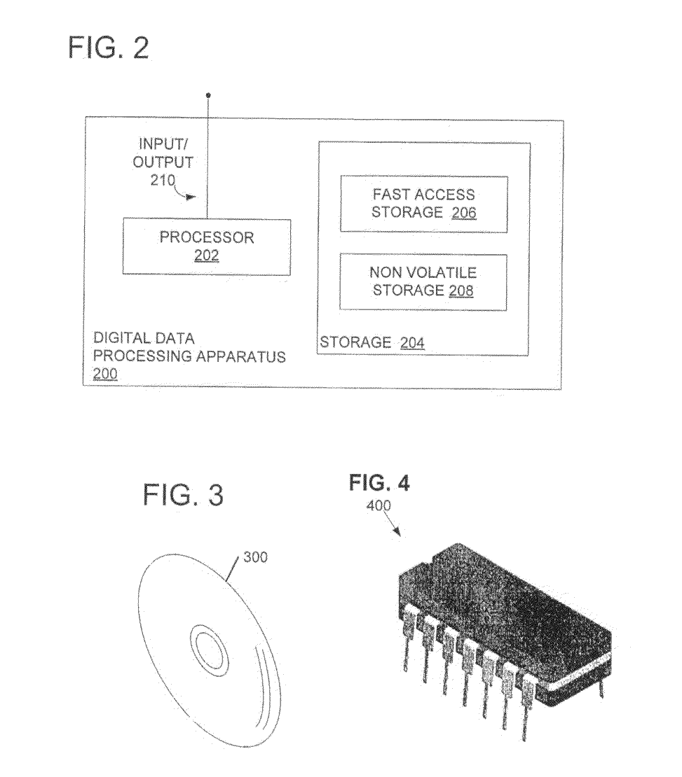

In FIG. 1A, there are various data processing components, such as the workflow engine 116, ERP manager 122, etc. These may be implemented by one or more hardware devices, software devices, a portion of one or more hardware or software devices, or a combination of the foregoing. The makeup of subcomponents such as these is described in greater detail below, with reference to FIGS. 2-4.

The system 100 includes digital data storage 102-103. The storage 103 is coupled to the ERP manager 122, and storage 102 is coupled to a workflow engine 116. The workflow engine 116 is additionally connected to the storage 103. The storage components 102, 103 are described in greater detail below.

Broadly, the ERP manager 122 monitors and selectively executes user-initiated tasks according to established rules defining users' permissions for such tasks. The rules are stored in 112, as discussed below. In one example, the manager 122 is an enterprise software product such as SAP R/3 or mySAP from SAP, PeopleSoft or Oracle Financials from Oracle Corporation, BPCS from SSA Global Technologies, Enterprise Business System from Made2Manage Systems, NetERP from NetSuite Inc., Microsoft Dynamics from Microsoft Business Division, Ramco e.Applications from Ramco Systems, SYSPRO ERP software from SYSPRO, etc. The workflow engine 116 is a novel product that supervises redefinition of the rules 112, which is needed from time to time to accommodate hiring, firing, promotions, system reconfiguration, mergers and acquisitions, corporate reorganization, and the like.

The components 116, 122 are accessible by any number of user interfaces. Two user interfaces 118, 120 are illustrated as one example. In this example, one interface 118 is used by an approver (a person), and the other interface 120 is used by a requestor (a person). However, the interfaces 118, 120 may be interchangeable, with the only difference being the user authentication sequence employed to log-on to the engine 116, manager 112, or both. The interfaces 118, 120 comprise any human-machine interface suitable for the purposes described herein, such as keyboards, video display, computer mice, or other interfaces without limitation. In a particular example, the interfaces 118, 120 provide web-based interfaces to the engine 116 and manager 122.

The components 116, 122, 118, 120 are interconnected via appropriate links, such as local or wide area network, Internet, corporate Intranet, portal, token ring, etc.

### Storage, Generally

Each module of storage 102, 103 can be implemented to use any type of machine-readable digital data storage suitable for the purposes described herein. Some examples include magnetic, optical, tape, disk, mainframe computer, distributed storage, mass storage device, server, supercomputer, personal computer, or any other storage without limitation. The modules 102, 103 may be separate (as shown) or integrated into one.

The storage 102 includes subcomponents 104, 108, 110, whereas the storage 103 includes the subcomponents 112-115. In either case, these subcomponents may be implemented by the same or different physical devices, logical devices, storage sectors or other regions, register, pages, linked list, relational databases, or other storage unit without limitation.

In one specific embodiment, the contents, interconnection, and operation of the storage 103 comprises a system such as SAP R/3 or mySAP ERP by SAP. Additional information about this product is available from sources such as the following, which are incorporated herein by reference. “SAP R/3 Administration for Dummies”, published April 1999, ISBN 0764503758. “SAP Planning: Best Practices in Implementation,” by Anderson et al., published May 2003, ISBN 0789728753. “Configuring SAP R/3 FI/CO: The Essential Resource for Configuring the Financial and Controlling Modules,” by Hurst et al., published April 2000, ISBN 0782125972. “SAP R/3 for Everyone: Step-by-Step Instructions, Practical Advice, and Other Tips and Tricks for Working with SAP,” by Mazzullo et al., published July 2005, ISBN 0131860852.

The subcomponents of storage 102, 103 are described in greater as follows.

### Resource

In the storage 103, the resource 115 represents stored data, processes, subroutines, application programs, or other actions or data that is the subject of ERP services by the manager 122. For instance, the resource 115 may comprise ERP system components operable to automate procurement, cash, collection, financial reporting, and other business processes. Optionally, the resource 115 may include non-ERP resources such as a file server, directory system, file sharing system, data repository, data library, etc. In still another example, the resource 115 may include components of a physical provisioning system, separately described below.

### Tasks

The storage 103 also contains a listing of tasks 113, which define transactions that the manager 122 is capable of conducting on behalf of users. Some examples include maintaining vendor master data, making payment, creating invoices, issuing billing documents, applying cash received, posting journal entries, recording invoices, processing payroll, and related accounting and finance entries.

### People

The people database 114 is a listing of people recognized by the system 100. For example, these may be employees and contractors of an entity on whose behalf the system 100 is operated. The people database 114 may include information about administrators or users of ERP tasks 113. As an example, the database 114 may list each person's name, employee ID, any “roles” associated with the person, and the like. The engine 116 has access to the people database 114 for purposes including collecting information about requesters and approvers during the process of passing a user request up through the necessary hierarchy of workflow stages 110.

### Rules

The rules 112 indicate who can perform the tasks 113 and when. In other words, the rules 112 indicate the necessary permission that a user must have in order to cause the ERP manager 122 to perform a task 113. The engine 116 has access to the rules 112 because, as described below, the engine manages and implements changes to the rules 112. These changes allow the ERP manager 122 to adapt as necessary to changes dictated by the organization that is operating the system 100, according to normal events such as hiring, firing, promotions, system reconfiguration, reorganizations, and the like.

In one example, the rules 112 are made up of a specification of predefined “roles.” Either the rules 112 or database 114 contains a mapping of which roles are assigned to which people. A role is a collection of tasks that a user is permitted to perform 113. There may also be composite roles, which are groups of single roles. In other words, a role is a grouping of job responsibilities that may be defined as functional tasks, such as creating invoices, paying invoices, etc.

### Workflows & Initiators

In the storage 102, the workflows 110 define various predefined approval paths, each path including one or more stages. Each workflow may also be referred to as a pattern or path. Broadly, workflows are an ordered collection of stages by which the engine 116 processes user requests to change the rules 112.

Workflow stages may also use access request field values (described below) to determine the appropriate approver. As an example, a workflow stage may use an access request value to route a request to the requestor's manager for approval. In one example, workflows 110 are comprehensive because each workflow stage contains all the information and tools needed to make a decision. Optionally, some workflows can be designed to use multiple paths. Multiple paths allow more than one workflow stage to be executed concurrently. Workflow paths can also include a detour path, which is a process to forward a request from one workflow to another. The detour is based on decisions made in a specific workflow stage. Further details of workflows 110 are described in greater detail below.

Before implementing any requested changes to the rules 112, the engine 116 makes sure to gather all necessary approvals, this being guided by the appropriate workflow path and its prescribed stages. Generally, when soliciting approval, the engine 116 sends out notices to various “approvers,” and these notices have the format and/or content prescribed by 108.

The engine 116 uses initiators 104 to decide which of the workflows 110 to select. Each initiator comprises a different combination of attributes of a user request. Each initiator can use some or all of the field values from a request form. Therefore, when the engine 116 receives a user request with a given set of attributes (i.e., prescribing one particular initiator), the engine 116 will activate a specific one of the workflows 110. In this respect, the initiators 104 may include (or have access to) further mappings 104a, 104b. One mapping 104a maps between user request attributes and initiators. In other words, this mapping 104a defines which sets of attributes of user requests constitute an “initiator.” The other mapping 104b maps between initiators 104 and workflows 110. In other words, this mapping 104b identifies the appropriate workflow 110 that should be started for each initiator defined by 104a. In the present example, initiators 104 are created and maintained by a system administrator (not shown).

Without any intended limitation, some exemplary attributes of user requests are listed as follows. Request type (e.g., new, change, lock, unlock, etc.). Request priority (e.g., critical, high, medium, low, etc.). Functional area (e.g., Finance, Procurement, HR, etc.). Company Applications (SAP Production (PRD), SAP Quality Assurance (QA), Legacy, etc., Physical Access).

Continuing with this same example, the following are some examples of initiators 104. A first initiator example is: a request for a new account to be created in SAP Production system for Finance user type, where this request is High priority. A second initiator example is: a request to change an existing Legacy Apps account to remove or add a role for an HR user, with critical priority. A third example of initiator is: a request to lock an existing Procurement user in SAP Production system, with critical priority request. A fourth example of initiator is: automated, low priority request by the ERP manager 122 (or self-generated request by the workflow engine 116) to delete access of a Finance user, responsive to the manager 102 receiving notice of a termination event from HR SAP.

Existence of a given initiator 104, then, effectively dictates which workflow 110 should be used by the workflow engine 116 in processing a given user request. Broadly, each workflow is a pattern of stages, each stage requiring that one or more “approvers” approve review and approve the user request (or a subpart of it). Each stage may further require its approver(s) to perform mandatory actions (or advise recommended actions) such as conducting segregation of duties or other risk analysis. At any stage throughout the request process, it is possible to make a risk analysis mandatory before approval may be given. When it is completed there are also provisions that make sure all issues are eliminated by removing other existing access from the user and/or by specifying an approved mitigating control alternative is assigned to the user before processing is allowed. If there are no appropriate alternative controls for the segregation of duty risk, then another alternative might be to create a mitigating control request and seek approval before continuing forward with the request.

Workflows 110 may include forks, detours, multiple parallel paths, branches, or any other prescribed routing that is fixed or based conditionally upon the output from one stage or another, information internal to the user request, external information about the requestor or approver or other fact, etc. In going from one stage to the next, the chosen workflow path may depend upon various conditions, such as input by first approver, results of analysis conducted by the first approver, input by other designees, or other relevant fact, selection, or input. In view of the foregoing, the workflow patterns are limited only by the imagination of the workflow designer.

### Examples of Workflows

FIG. 1B shows several exemplary workflows. The workflow 151 includes three stages 152, 154, 156 in series. In this example, the workflow 151 requires approval by an approver (stage 152), then the approval by the approver (stage 154), and finally approval by the approver (156). If any approver rejects, the workflow 151 collapses, and completes prematurely with the ultimate answer being “denied”.

The workflow 157 shows a different example. This workflow includes three stages 158, 160, 161; here, the stage 160 includes two components 160a, 160b. First, a first stage approver must approve the request in stage 158. Then, either one of two second stage approvers (subparts 160a, 160b) must approve. Finally, a third stage approver must approve the request (step 161).

As shown by the examples above, each stage of a workflow may require an approver to issue an approval or denial. Workflows may be designed with different or added actions in each stage. For instance, stages may require or recommend that the approver to conduct a computer-generated risk analysis, to enter manually computed or researched information, etc. In this spirit, the workflow 165 provides an example or a more complicated workflow. Here, a first stage 166 requires its approver to enter certain information. If this information cannot be submitted completely, the workflow exits the stage 166 via 166a and ends (168). The user request must be submitted anew when the relevant information becomes available. If the approver does enter all required information, however, stage 166 proceeds to the next stage 170 via 166b. Based on its approver's input, stage 170 branches to one of the approvers 172, 174. For instance, if the approver of stage 170 cannot find certain information, this stage 170 automatically routes the workflow to personnel of stage 172 to get this information as a required condition to entering the final stage 174.

### Dynamic Workflow Changes

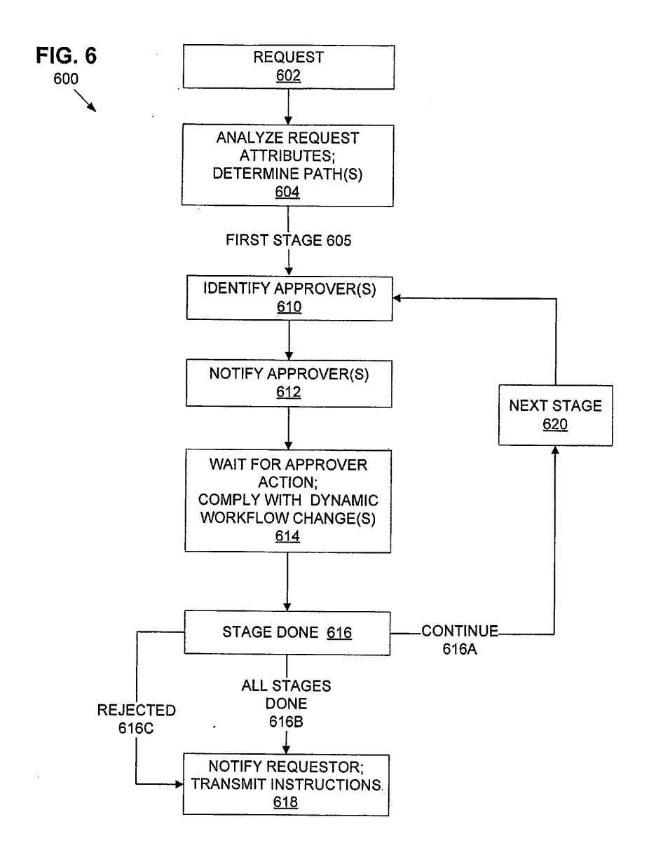

As shown above, each workflow pattern may include a variety of different pre-set patterns such as lines, forks, circuit, parallel paths, branches, and the like. Beyond the designed layout of the workflows, however simple or complicated, the workflows may be subject to certain dynamic changes. Changes to a workflow stage are made at the direction of that stage's approver, and as such, these changes are said to be made “on-the-fly.” This is discussed in greater detail below in the context of FIG. 6. To provide some examples, however, reference is now made to FIG. 1C.

Basically, an approver can make limited types of changes to the workflow on-the-fly, since the basic workflow path/pattern is fixed. The approver can perform actions such as sidetrack (179), delegate and report back (183), and re-route (187). FIG. 1C illustrates these actions in the context of various partial workflows (with unrelated stages not shown).

In example 179, the workflow pattern proceeds through a stage 180 via 180a, 180b. Here, the stage 180 approver recognizes that further work still needs to be done, so the approver requests that another person (stage 182) take certain action, and after that, somebody submit the request anew. As a specific example, the sidetracking a request can occur when an approver is seeking advice from another person on the appropriateness of a request. An example is if the approver wants to check with a former manager to see if some of the existing access the requester has is still necessary. Based on the response the manager might choose to remove access. Or it might be the approver is unsure of access being requested for an area outside his knowledge and he forwards the request for another to approve and then continue on in the process, or to advise him and return the request for his approval or rejection and then forwarding on in the process.

In example 183, the stage 184 approver requires another actor (stage 186) to take action and report back to the approver 184. Accordingly, the workflow proceeds from the approver 184 to the delegate 186 (via 184b), and after the delegate takes action, back to the approver 184 (via 184a). This situation may be useful, for example, when the approver 184 requires further information from another person, but the approver wants to retain control of making the approval decision. Some examples of the scenario 183 include a situation where a new approver wants to seek technical advice and wants a second opinion before rendering an approval or rejection decision. Is this mitigating control assignment an appropriate action for this situation? Many of the approvers do not have the control knowledge so they seek it from a control specialist.

In example 187, the stage 188 approver re-routes the workflow from the normal path 188b. For example, the approver assigns his/her capacity of approval to another actor (stage 190), and the workflow progresses to the next stage 192 via 188a, 190a instead of 188b. This situation may be useful, for example, when the approver 188 does not have time to duly consider the user request, or realizes that another person is more qualified to make the decision. In another embodiment of this workflow 187, the approver 188 routes flow to the actor 190 to gather information that is unavailable to the approver 188, en route to the final stage 192. Moreover, in a physical provisioning scenario (i.e., where the resource 115 is a physical asset), the approver may in fact be an external system that supports the physical process in some way. For instance, a part of a person's physical access to a site might require the completion of a range of training certifications. In this case the workflow might progress to a training approver or it might in fact be integrated with a training system that accepts requests for access to site and automatically books any outstanding training requirements and advises the earliest completion and compliance date available for the person to access the site.

### Exemplary Digital Data Processing Apparatus

As mentioned above, data processing entities (such as the workflow engine 116 and manager 122 and others) may be implemented in various forms.

Some examples include a general purpose processor, digital signal processor (DSP), application specific integrated circuit (ASIC), field programmable gate array (FPGA) or other programmable logic device, discrete gate or transistor logic, discrete hardware components, or any combination thereof designed to perform the functions described herein. A general purpose processor may be a microprocessor, but in the alternative, the processor may be any conventional processor, controller, microcontroller, or state machine. A processor may also be implemented as a combination of computing devices, e.g., a combination of a DSP and a microprocessor, a plurality of microprocessors, one or more microprocessors in conjunction with a DSP core, or any other such configuration.

As a more specific example, FIG. 2 shows a digital data processing apparatus 200. The apparatus 200 includes a processor 202, such as a microprocessor, personal computer, workstation, controller, microcontroller, state machine, or other processing machine, coupled to digital data storage 204. In the present example, the storage 204 includes a fast-access storage 206, as well as nonvolatile storage 208. The fast-access storage 206 may be used, for example, to store the programming instructions executed by the processor 202. The storage 206 and 208 may be implemented by various devices, such as those discussed in greater detail in conjunction with FIGS. 3 and 4. Many alternatives are possible. For instance, one of the components 206, 208 may be eliminated; furthermore, the storage 204, 206, and/or 208 may be provided on-board the processor 202, or even provided externally to the apparatus 200.

The apparatus 200 also includes an input/output 210, such as a connector, line, bus, cable, buffer, electromagnetic link, network, modem, or other means for the processor 202 to exchange data with other hardware external to the apparatus 200.

### Signal-Bearing Media

As mentioned above, various instances of digital data storage may be used, for example, to provide storage used by the system 100 such as storage 102, 103 (FIG. 1), to embody the storage 204 and 208 (FIG. 2), etc. Depending upon its application, this digital data storage may be used for various functions, such as storing data, or to store machine-readable instructions. These instructions may themselves aid in carrying out various processing functions, or they may serve to install a software program upon a computer, where such software program is then executable to perform other functions related to this disclosure.

In any case, the signal-bearing media may be implemented by nearly any mechanism to digitally storage machine-readable signals. One example is optical storage such as CD-ROM, WORM, DVD, digital optical tape, disk storage 300 (FIG. 3), or other optical storage. Another example is direct access storage, such as a conventional “hard drive”, redundant array of inexpensive disks (“RAID”), or another direct access storage device (“DASD”). Another example is serial-access storage such as magnetic or optical tape. Still other examples of digital data storage include electronic memory such as ROM, EPROM, flash PROM, EEPROM, memory registers, battery backed-up RAM, etc.

An exemplary storage medium is coupled to a processor so the processor can read information from, and write information to, the storage medium. In the alternative, the storage medium may be integral to the processor. In another example, the processor and the storage medium may reside in an ASIC or other integrated circuit.

### Logic Circuitry

In contrast to signal-bearing media that contain machine-executable instructions (as described above), a different embodiment uses logic circuitry to implement the workflow engine 116 and any other processing features of the system 100. Depending upon the particular requirements of the application in the areas of speed, expense, tooling costs, and the like, this logic may be implemented by constructing an application-specific integrated circuit (ASIC) having thousands of tiny integrated transistors. Such an ASIC may be implemented with CMOS, TTL, VLSI, or another suitable construction. Other alternatives include a digital signal processing chip (DSP), discrete circuitry (such as resistors, capacitors, diodes, inductors, and transistors), field programmable gate array (FPGA), programmable logic array (PLA), programmable logic device (PLD), and the like.

FIG. 4 shows an example of logic circuitry in the form of an integrated circuit 400.

### Operation

Having described the structural features of the present disclosure, the operational aspect of the disclosure will now be described. The steps of any method, process, or algorithm disclosed herein may be embodied directly in hardware, in a software module executed by hardware, or in a combination of the two.

### Overall Operating Sequence

FIG. 6 shows a sequence 600 to illustrate one example of the method aspect of this disclosure. This sequence is performed in a system where a computer-driven resource manager monitors and selectively executes user-initiated tasks according to established rules defining users' permissions for such tasks, and in particular, this sequence concerns a method of managing redefinition of those rules. Broadly, a requester submits a request to change the rules, and the engine 116 iteratively collects approvals from all appropriate personnel, and ultimately sends the final result to the requestor in the form of a computer-readable message.

Beneficially, the sequence 600 helps standardize the decision making process for approving requests and provides a comprehensive view of the information needed to make informed decisions. Additionally, the process 600 ensures that appropriate departments are included in the request approval process by automatically identifying and routing requests to authorized approvers in each workflow.

For ease of explanation, but without any intended limitation, the example of FIG. 6 is described in the specific context of the system 100 described above (FIGS. 1A-1C).

The steps are initiated in step 602, when the workflow engine 116 receives a request to change the rules 112. The request 602 may be user generated (i.e., originating from a human user) or system generated (i.e., originating from a process of the ERP manager 122).

The person or process seeking to change the rules 112 is referred to as a requester. The request concerns a request to add, delete, change, or create a role, either for the requestor him/herself or for another. In other words, a request is a means by which the requestor seeks to change a set of security accesses and permissions, and therefore change the rules 112.

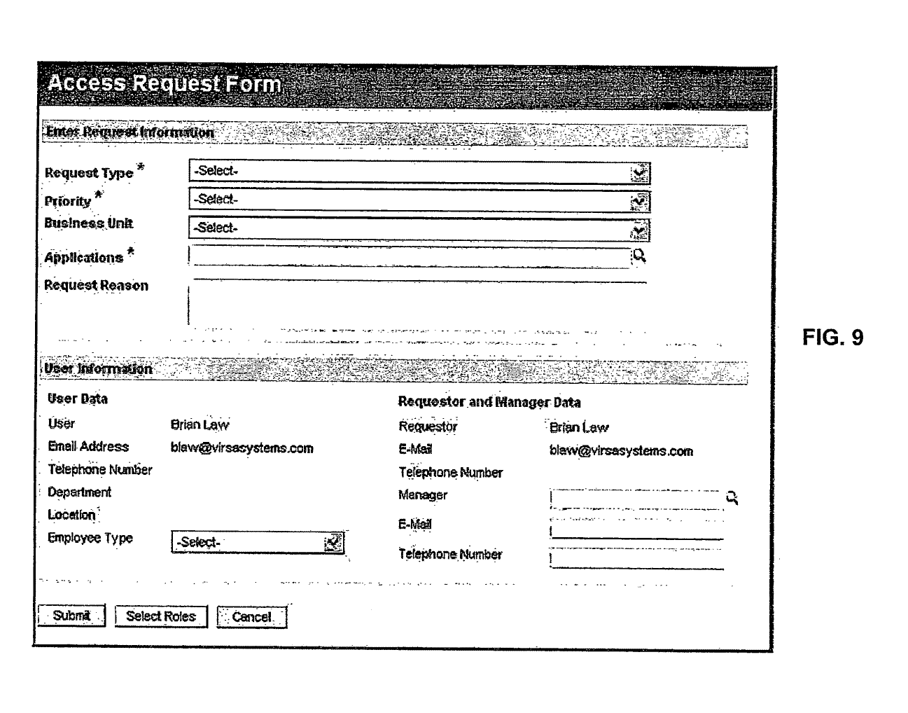

In one example, the requester submits the request by using a web-based interface 120 to complete and submit a pre-defined form provided by the engine 116. For instance, the user may gain access to the engine 116 by entering a known URL of the engine 116 into a web browser. As part of the request process 602, the engine 116 may require the requestor to satisfy a predetermined authentication process, such as username and password, etc. FIG. 9 shows one example 900 of a request a form. In completing the request, the requester enters information such as: identification of requester, identification of applicable manager(s), roles to be assigned to the user, applicable business unit, name of application for which access is sought, reason for request, employee category, whether access is sought to a role or transaction or object, etc. Some exemplary requests include actions such as NEW, CHANGE, LOCK, UNLOCK, DELETE, etc. The user may also enter a request priority, such as high, medium, or low.

The NEW request seeks a new role, whereas the CHANGE request seeks to change a role. The LOCK seeks to lock a users account so it cannot be utilized and UNLOCK is to make a user account operative again. The DELETE request seeks to remove a user's account from the target system. In a physical provisioning system, a LOCK request disables all access for a person to the physical site and its components. In this environment an UNLOCK request re-enables all accesses that were previously disabled, or that which the person has on their record at the time that the UNLOCK is approved and processed.

In step 604, the engine 116 analyzes contents of the request in order to determine an appropriate one (or multiple ones) of the workflow paths from 110. In one example, this is performed by the engine 116 parsing the request, consulting the map 104a to determine whether the parsed components constitute one of the initiators 104, and then consulting the map 104b to determine which of the workflows 110 corresponds to this particular initiator. Optionally, in determining which of the initiators 104 is presented by the user request, the engine 116 may take further steps in order to actively gather related information about the requester (and/or the request) from the people database 114. This ensures that the most up-to-date information is available to the engine 116 and the future approvers to accurately consider the request.

As mentioned above, each workflow path has a number of stages, and one or more prescribed orders of progression through the stages. Therefore, having identified the appropriate path in step 604, the next operation of the routine 600 is to start processing (605) the first stage. Namely, in step 610 the engine 116 identifies the first approver(s) relevant to the current stage of the workflow path selected in 604.

There may be two (or more) approvers that share the first stage, in which case step 610 identifies all approvers. Depending upon the implementation, an approver may be a role, a job title, or a specific person. There may be different types of approvers, with different permissions: role owner approvers, security approvers, manager approvers, physical access level owners, etc.

Step 610 is performed by the engine 116 examining the selected workflow path to first identify the relevant role (approver), and then cross-referencing this information against the people database 114 to find out who occupies the given role(s). In other words, user information is extracted from storage (such as 114) as the request moves through each stage in the workflow process, ensuring that the most up-to-date info is available at each step of the workflow cycle.

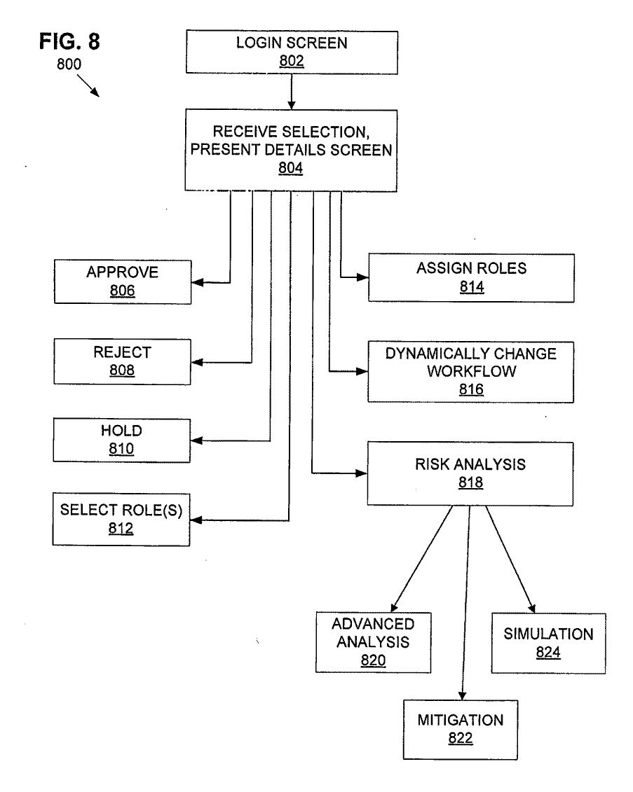

Accordingly, in the next step (612), the engine 116 transmits electronic notification to the identified approver(s). These notifications utilize the format, syntax, language, theme, or other guidelines specified by the predefined notices 108. For ease of discussion, the present example uses the case where there is one approval in the current stage. The notification may be embodied in any type of machine-transmitted notification, with email being one example. In one example, each approver's notification (612) is an email prompting the approver to log-in to the workflow engine 116. The current stage's approver(s) respond as described in FIG. 8, which is separately described below.

After step 612, step 614 waits for action by the approver that was notified in step 612. For example, the approver of the current stage may approve or deny the request. Or, if the request has separate subcomponents, the approver may approve some and deny others. Additionally, the approver may perform various dynamic modifications to the workflow, such as sidetrack, delegate and report back, and/or re-route. The menu of potential approver actions is discussed in greater detail below in the context of FIG. 8. Optionally, step 614 may apply a timeout provision, in which the engine 116 denies the request if all actions of a given approver or stage are not received in a given time.

Task 616 occurs when the current stage is complete. Task 616 advances to step 620 via 616a when the engine 116 finds that it has received all approvals required by the current stage, but the present workflow still contains unfinished stages. In situations where a stage requires approval of several roles with different owners, the engine 116 requires approval from all roles before advancing (620) to the next stage. Similarly, if a stage requires approval of multiple items, then the engine 116 ensures collection of all required responses before moving to the next stage.

Generally, the operations 610-616 repeat in a loop until step 616 finds that one of the following has occurred: (1) all components of the user's request have been rejected, in which case step 616 advances to 618 via 616c, or (2) the engine 616 has collected all approvals of all stages, in which case step 616 advances to 618 via 616b.

After step 616 moves to 618, the engine 116 transmits electronic notification of the rejection (or approval) to the requestor. In the case of approval, step 618 takes the additional step of transmitting instructions to appropriate personnel or computing equipment to implement the requested and now-approved changes to the rules 112. In one example, step 618 transmits the instructions to a system administrator, who implements the rule changes in FIG. 7, as described in greater detail below.

### Approver Actions

As mentioned above, the engine 116 sends each approver a notification (step 612, FIG. 6) such as an email prompting the approver to log-in to the workflow engine 116. In other words, each approver receives a system generated message notifying him/her of a new request for which his/her approval is sought. In one example, the notification (not shown) directs the approver, for example by hyperlink, to log-in to a web page provided by the engine 116. The engine 116 tailors this web page specifically for that approver.

When the approver logs-in to this web page, this begins a sequence of operations whereby the workflow engine 116 presents various options to treat this request and act on those options. This sequence is described by the operations 800 of FIG. 8, in one example. Without any limitation, this sequence 800 is discussed in the context of the system 100 of FIGS. 1A-1C. The sequence 800 is largely performed by the workflow engine 116, although certain steps are performed by the ERP manager 122 in this example.

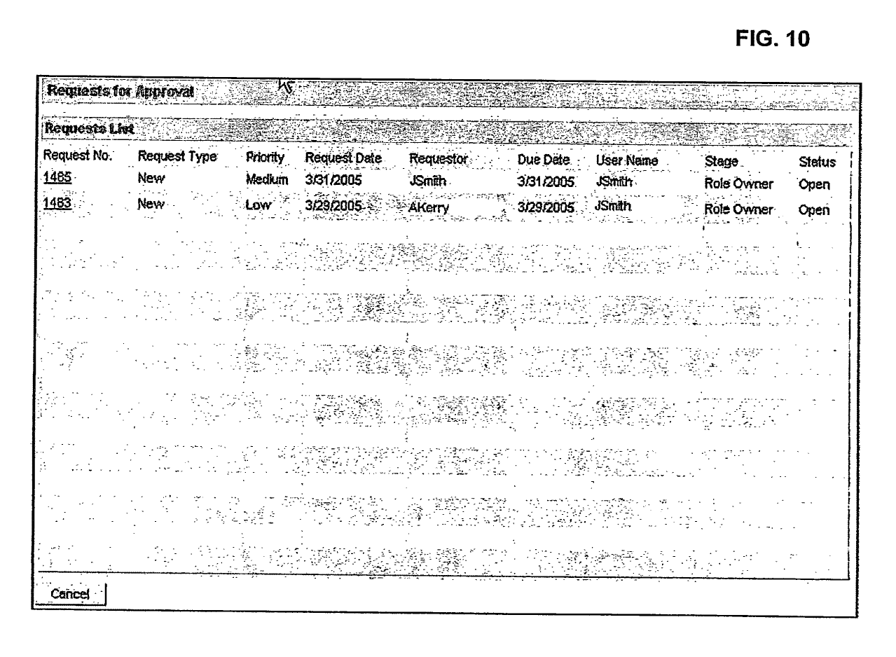

In step 802, the approver logs-in to the approver-specific web page provided by the workflow engine 116. FIG. 10 shows a sample of this web page. In this example, the web page automatically identifies each request for which the approver's approval is sought, and presents various information about the request, such as request type, priority, request date, requester, due date, and the like. This screen may explicitly or implicitly prompt the approver to select one of the pending requests. In certain cases, step 802 may bypass the logon, in which case the engine 116 directs the approver directly to the request information without having to go through the logon screen.

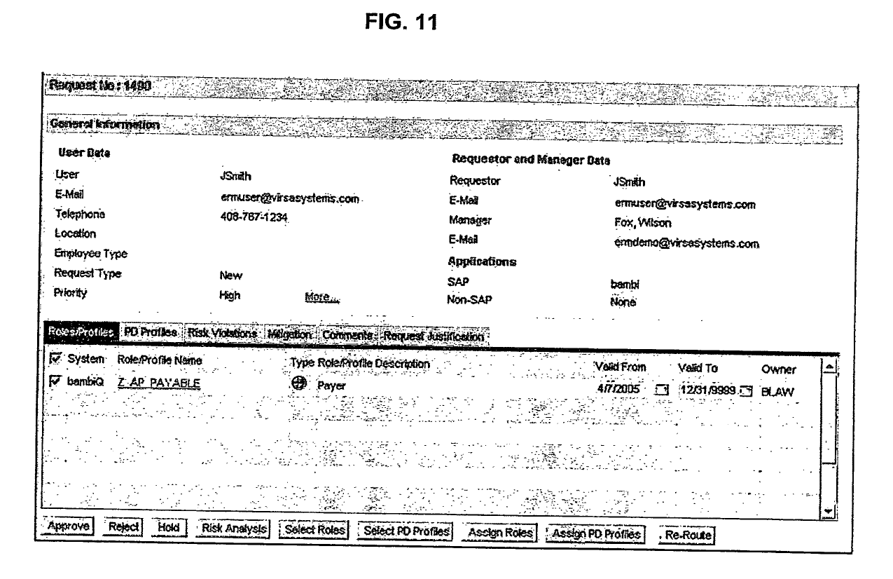

In step 804, the engine 116 receives the approver's selection of one of the listed pending requests, and presents a details screen concerning that request. In other words, the approver clicks on the desired request to act upon that request, and the engine 116 presents a follow-up screen specific to the selected request. FIG. 11 shows an example of the request details screen for a sample request. The request details screen presents various options for the approver to act upon the selected request. In one option, there is a set of standard approver actions, presented as GUI buttons proximate the displayed request. The engine 116 may hide some or all buttons if approver is not granted access to those functions according to the stage of the workflow being processed.

In the present example, the approver has the following options: approve 806, reject 808, hold 810, select roles 812, assign roles 814, dynamically change workflow 816, and or perform risk analysis 818. As an optional follow up to the risk analysis operation 818, the engine 116 presents advanced analysis 820, mitigation 822, and simulation 824. The operations 806-824 are discussed in greater detail below.

In tasks 806, 808 the engine 116 receives the approver's approval or denial of the requested action. In either case, this ends the sequence 800, and the approver's work is finished. In situations where the current request actually includes a bundle of requests, then the approver may act (806, 808) to approve or deny each request individually. Approval of one or more bundled request with denial of other requests is referred to as “partial” approval or denial.

In step 810, the engine 116 receives the approver's election to “hold” some or all of the current request, or to remove a hold previously placed. In one embodiment, the approver may place a complete hold, which stops the process 600 until the approver releases the hold. In another embodiment, the approver places a hold/delay, whereupon the engine 116 continues the remaining aspects of the process and later comes back to obtain the approver's decision before advancing finally from step 616 to step 618. This may be useful, for example, if the approver expects to delay his decision for some reason, but does not want to slow the overall process of acting on the request. In the case of multiple bundled requests, the approver may place a hold on certain requests (a “partial” hold), and act immediately on other requests.

Step 812 receives the approver's election to select one or more roles. The “selection” of roles involves forming, modeling, cloning, constructing, or otherwise preparing a role to be assigned (814) to the requestor. Optionally, the work engine 116 may perform role modeling, under the approver's direction, to clone roles from one user profile to another, and also to clone the roles' security access. Step 812 is implemented by the ERP manager 122, and in a more specific example, by selecting roles from a connected SAP system or target system or uploaded from a remote site.

After selecting roles (812), then approver can assign the role to (or remove a role from) a given person in step 814. More particularly, step 814 involves the engine 116 receiving the approver's election to assign roles to the requestor (or person or role on whose behalf the requester is acting). Roles may be assigned manually, through modeling, or both. “Direct” assignment assigns roles to a specific person, whereas “indirect” assignment assigns roles to a position or job, which in turn has users assigned to the job or position. Once a role is assigned (814) to a user, the corresponding tasks 113 are automatically assigned. In one example, step 814 is implemented by the ERP manager 122, and in a more specific example, by using certain functions of an SAP system.

Before a role is assigned, the routine 800 may optionally permit, or make mandatory as per the details of the workflow, the approver's running a risk analysis (818, described below) on the selected role. The mandatory or permissive nature of risk analysis may be variable based on the situation (i.e., the nature of the user request), fixed according to implementation of the system 100, or set as prescribed by the current workflow stage.

As an alternative or additional feature to step 812, step 812 may propose, make mandatory, filter, or otherwise suggest a set of roles to the approver. In one example, the ERP manager 122 recognizes a group of user-defined functional areas pertaining to business of the organization that operates the system 100. Some examples may be Production Ops, Accounting JV, California Development, etc. In this example, based upon the requestor's identifying a functional area in his/her request, step 812 may incorporate a predetermined set of roles (appropriate to the specified functional area) into the workflow, rather than relying on the approver(s) to select them. Specifically, step 812 then consults a predetermined mapping between the functional areas and all associated roles, limiting its proposal of roles to the approver to those specifically associated with the functional area relevant to the user request. In addition, step 812 may identify other default roles that need to be added to the request in addition to the roles selected by the requester or role selector. Namely, step 812 uses a predefined list to propose the addition of further default roles appropriate to the user's request or the approver's selection. For example, if the approver has proposed creation of an AP Clerk role, then step 812 may propose that the additional roles “Read Display” and “Print” be included.

In step 816, the engine 116 receives the approver's election to delegate or re-route the approver's authority to act on the subject request. Dynamic workflow changes may occur manually, for example if the approver initiates the changes because s/he does not have time to address the request, or automatically if the approver is on vacation or another reason. With delegation, the approver designates another person or role in the company, and delegates responsibility for making the approver's decision to the designated person or role. In one example, the workflow engine 116 may automatically delegate the approver's decision to another when the engine 116 has received information (from the approver or elsewhere) that the approver is on vacation, on extended travel, on extended leave, etc. With re-routing, the approver routes the current request to another for his/her input, after which the flow returns to the approver to finish deciding upon the request. This may be useful for the approver to gain another's experience, insight, or opinion before making the final decision on the current request. Other options for dynamically changing workflow are discussed above in the context of FIG. 1C.

Upon entry of a dynamic workflow change, the workflow engine 116 adds this stage to the workflow, and continues by identifying and notifying the delegate in the same manner as steps 610, 612 described above.

In step 818, the engine 116 receives the approver's election to perform risk analysis. In one example, step 818 and the follow up tasks 820-824 may be implemented by incorporating software features of the Compliance Calibrator version 5.0 product of Virsa Systems, Inc. In risk analysis, the engine 116 responds to the approver's request by evaluating roles for potential conflicts or audit exceptions through segregation-of-duties analysis. In other words, step 818 analyzes the user request to determine if fulfilling request would violate regulatory compliance, audit rules, company policy, or other rules, laws, or predetermined guidelines. Risk analysis is executed to make sure there are no violations in access of roles, and constitutes a proactive action to avoid conflicts. Risk analysis 818 includes, for example, checking a set of prospective roles or security permissions for compliance and audit exposure. Risk analysis can be performed before or after assigning (814) roles to an access request, and whether the assigned roles have been created (812) manually or through modeling upon existing profiles.

As an optional follow up to the risk analysis operation 818, the engine 116 presents advanced analysis 820, mitigation 822, and simulation 824. In mitigation 822, the engine 116 facilitates approver creation of mitigation controls to address risk exposure. Mitigation is an action to take care of the violation based on defined rules. A mitigation control exempts or overrides an identified risk or prospective audit exception, permitting it to occur even though it violates one or more rules 112. Having selected a specific segregation of duties violation, the approver can override the violation with a management approval that is captured in the system to maintain an audit trail.

In simulation 824, the approver proposes a hypothetical situation and the engine 116 examines the scenario to determine it would pose any risks. This includes a process of identifying whether proposed roles would generate segregation of duties violations. When segregation of duties violations are generated, the approver can go back, de-select (812) roles one-by-one, and re-simulate (824) the effects of that modified profile. This allows the approver to check whether the proposed role(s) continue to pose segregation of duties violations, and at what point they stop. In this way, the approver can also identify which specific role or combination of roles causes the segregation of duties violations.

In one embodiment, after a risk analysis is conducted (818), the workflow engine 116 automatically limits the approver's ability to select the approve (806) option. For example, the workflow engine 116 may only permit approval (806) if the risk analysis 818 does not reveal any unmitigated segregation of duties violations, risks, or other exposure.

### Preparatory Operations

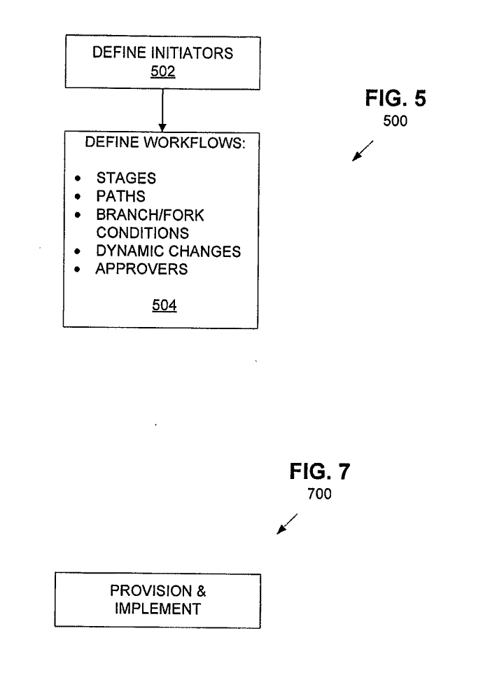

FIG. 5 shows a sequence 500 of operations performed in preparation for the sequence 600. These operations 500 may be performed at installation of the system 100, configuration, reconfiguration, upgrade, purchase, or another appropriate time. In one example, the operations 500 are performed manually by a system administrator, and more particularly, this involves the administrator's actions in setting up, modifying, updating, upgrading, or otherwise changing the initiators 104, workflows 110, and/or notices 108. As an alternative to the system administrator, the operations 500 may be performed by an automated system such as an expert system, neural network, or other software program. In the remaining description, however, the operations 500 are performed by a system administrator.

In step 502, the system administrator defines the initiators. Here, the administrator plans the various initiators 104 and maps 104a-104b. These operations may be performed, for example, by the administrator populating a list, database, table, or any other suitable data structure, computing algorithm, hardware device, or utility.

In step 504, the system administrator defines workflows 504. This may be performed in similar manner to the operation 502. For each workflow, step 504 defines the number of stages, relationship and paths between stages, branch/fork conditions, availability of dynamic workflow changes (or not) at east stage, and which role(s) or person(s) constitute the proper approver for each stage.

### Follow-Up Operations

FIG. 7 shows operations 700 performed in response to the instructions (ref. 618, FIG. 6) from the workflow engine 116 as to amendment of the rules 112. In particular, responsive to the instructions, actions are taken to reconfigure software settings of the system 100 to implement the amendment of the rules 112. In one example, these actions (700) are performed by a system administrator creating or modifying any necessary user accounts, assigning roles to perform, etc. In the exemplary context of an SAP resource 115, step 700 may be satisfied by a system administrator utilizing SAP software to create, delete, or modify a role or perform other actions to satisfy the approved request.

As an alternative to manual operations by the system administrator, the operations 700 comprise auto-provisioning actions performed by an automated system such as the workflow engine 116. This enables the requested actions, if approved, to be carried out substantially in real time. In one example, provisioning involves completing the addition of a user account or assigning the roles to a user account outlined in the request. The implementing operation (700), as an example, involves sending a non-ERP system request to a designated person, asking him/her to manually complete the request. One example of step 700's implementation is approval of a request for a user to access certain data in a mainframe system that is outside the resource 115. Another example of is a request for a person to complete a new employee packet for a new hire in HR department.

### Physical Provisioning

One example of the resource 115, described above, includes various stored data, processes, subroutines, application programs, or other actions or data that is the subject of ERP management by the manager 122. Examples of the resource 115 were said to include information utilized by ERP and similar functions used in SAP, Oracle Financials, PeopleSoft, or other systems to automate procurement, cash, collection, financial reporting, and other business processes.

In a different or additional embodiment, the resource 115 may include data, processes, computing hardware, electronics, devices, or actions relating to building security or so-called “physical provisioning.” In this embodiment, the resource 115 includes various remotely operated facility security components such as door locks, alarm systems, access zones, controllers, boom gates, elevators, HVAC systems and components, readers (card, biometric, RFID etc), Positive ID Readers (PIRs) and the events and alarms that are generated by these components. It can also be extended to include other devices such as photocopiers, POS systems, transportation access (charge) points and other such systems that can be incorporated on smart card or other physical access technology.

In the physical provisioning context, the tasks 113 include acts of opening the door locks, deactivating the alarm systems, granting and revoking access to physical areas, and the like. In processing these tasks, the ERP manager 122 receives and evaluates individual user authentication from interfaces such as 118, 120. User authentication may utilize keypad passcode, biometric identification (e.g., fingerprint, iris/retina scan), user name and password submittal, presentation of magnetic stripe card, proximity card, smart card, use of a radio frequency identification (RFID), etc. The ERP manager 122 considers information such as the user's role and other characteristics (from 112, 114) to determine whether to perform the requested task (113) on behalf of the user.

Insofar as the building security aspect, the ERP manager 122 may employ technology such as the commercially available products of CARDAX, GE, Honeywell, or others. Similar to the rules 112 as discussed above, the rules for physical provisioning are designed to prevent segregation of duties violations. For instance, risk is likely posed by a situation where the same person has access to both a chemicals storage area (ammonium nitrate for example) as well as access to the tarmac area of an airport at a connected facility. With the addition of the physical aspect, the ERP manager 122 can also implement rules 112 that are designed to prevent segregation of duties violations across the physical and logical landscapes simultaneously. For instance, risk is likely to be posed by a situation where a person has access to the inventory storage area while at the same time belonging to a role which allows them to perform inventory write-offs in the ERP system. The physical aspect will also deliver data to the ERP Manager 122 to allow it to reference rules 112 about whether or not a person has been physically at a site for too long in one continuous time span; or if a person has not had sufficient time away from a work site between physical visits; or where a person has exceeded certain regulatory exposure limits to toxic or radioactive substances for example.

In these examples, the workflow engine 116 operates similar to the description above. Namely, the engine 116 utilizes the components 102 to aid in processing user's requests to change the rules 112 by which the manager 112 manages building security. For example, a user's request may seek access to a room or building for which the rules 112 do not authorize access. User requests may also seek to remove, expand, change, or otherwise amend access to building security features managed by the ERP manager 122.

### OTHER EMBODIMENTS

While the foregoing disclosure shows a number of illustrative embodiments, it will be apparent to those skilled in the art that various changes and modifications can be made herein without departing from the scope of the invention as defined by the appended claims. Accordingly, the disclosed embodiment are representative of the subject matter which is broadly contemplated by the present invention, and the scope of the present invention fully encompasses other embodiments which may become obvious to those skilled in the art, and that the scope of the present invention is accordingly to be limited by nothing other than the appended claims.

All structural and functional equivalents to the elements of the above-described embodiments that are known or later come to be known to those of ordinary skill in the art are expressly incorporated herein by reference and are intended to be encompassed by the present claims. Moreover, it is not necessary for a device or method to address each and every problem sought to be solved by the present invention, for it to be encompassed by the present claims. Furthermore, no element, component, or method step in the present disclosure is intended to be dedicated to the public regardless of whether the element, component, or method step is explicitly recited in the claims. No claim element herein is to be construed under the provisions of 35 USC 112, sixth paragraph, unless the element is expressly recited using the phrase “means for” or, in the case of a method claim, the phrase “step for.”

Furthermore, although elements of the invention may be described or claimed in the singular, reference to an element in the singular is not intended to mean “one and only one” unless explicitly so stated, but shall mean “one or more”. Additionally, ordinarily skilled artisans will recognize that operational sequences must be set forth in some specific order for the purpose of explanation and claiming, but the present invention contemplates various changes beyond such specific order.

In addition, those of ordinary skill in the relevant art will understand that information and signals may be represented using a variety of different technologies and techniques. For example, any data, instructions, commands, information, signals, bits, symbols, and chips referenced herein may be represented by voltages, currents, electromagnetic waves, magnetic fields or particles, optical fields or particles, other items, or a combination of the foregoing.

Moreover, ordinarily skilled artisans will appreciate that any illustrative logical blocks, modules, circuits, and process steps described herein may be implemented as electronic hardware, computer software, or combinations of both. To clearly illustrate this interchangeability of hardware and software, various illustrative components, blocks, modules, circuits, and steps have been described above generally in terms of their functionality. Whether such functionality is implemented as hardware or software depends upon the particular application and design constraints imposed on the overall system. Skilled artisans may implement the described functionality in varying ways for each particular application, but such implementation decisions should not be interpreted as causing a departure from the scope of the present invention.

The previous description of the disclosed embodiments is provided to enable any person skilled in the art to make or use the present invention. Various modifications to these embodiments will be readily apparent to those skilled in the art, and the generic principles defined herein may be applied to other embodiments without departing from the spirit or scope of the invention. Thus, the present invention is not intended to be limited to the embodiments shown herein but is to be accorded the widest scope consistent with the principles and novel features disclosed herein.

What is claimed is:

1. In a system where a computer-driven resource manager selectively executes user-initiated tasks according to established rules defining users' permissions for such tasks, a method of managing redefinition of the rules comprising operations of:
a computer-driven workflow engine receiving a request to change the rules, the request comprising submission of a completed predefined electronic form by a requester;
responsive to receiving the request, the workflow engine processing the request by performing operations comprising:
reviewing data in the completed electronic form and selecting a corresponding one of multiple predefined approval paths;
in an order prescribed by the selected path, performing operations comprising:
sequentially proceeding through a sequence of one or more stages defined by the selected approval path, where in each stage the workflow engine electronically solicits approvals from one or more approvers indicated by the selected approval path;
continuing through the stages until the workflow engine receives a completion event comprising one of the following: at least one denial, or all approvals required by the selected approval path;
responsive to receiving all approvals required by the selected approval path, transmitting an electronic message directing amendment of the rules according to the request.

2. The method of claim 1, the operations further comprising:
transmitting electronic notification of each completion event to the requester.

3. The method of claim 1, the operations further comprising:
responsive to receiving the electronic message directing amendment of the rules, a human system administrator reconfiguring software settings of the resource manager to implement the amendment of the rules.

4. The method of claim 1, the operations further comprising:
computer-driven equipment receiving the electronic message directing amendment of the rules and, in response thereto, reconfiguring software settings of the resource manager to implement the amendment of the rules.

5. The method of claim 1, where:
the operations further include establishing a set of initiators, the initiators comprising different possible completions of the predefined electronic form, and defining an association between the initiators and the predefined approval paths;
the operation of reviewing data in the request and selecting a corresponding one of multiple predefined approval paths comprising:
reviewing data in the completed electronic form to identify a corresponding initiator;
determining which predefined approval path is associated with the identified initiator;
selecting the associated approval path

6. The method of claim 1, the operations further comprising:
a human system administrator defining the predefined approval paths and directing computer-driven equipment to prepare a machine-readable record of the predefined approval paths, the record accessible by the workflow engine.

7. The method of claim 1, where the following features are present in the predefined approval paths: parallel paths, conditional branches.

8.-9. (canceled)

10. The method of claim 1, further comprising:
responsive to the workflow engine receiving directions from one or more of the approvers indicated by the selected approval path to dynamically change the selected approval path, implementing the dynamic changes.

11. The method of claim 1, further comprising:
in one or more of the stages, receiving and implementing any directions of the approvers indicated by the selected approval path to dynamically change the selected approval path, the directions including: sidetracking approval, delegating for report-back, rerouting approval.

12. The method of claim 1, further comprising in one or more of the stages, additional operations comprising:
responsive to approver selection of a risk analysis option, computer-driven equipment analyzing the request as received from the requestor or modified or proposed by the approver to determine if fulfillment thereof would violate predetermined guidelines as to segregation of duties, regulatory compliance, or audit rules.

13. The method of claim 1, further comprising in one or more of the stages, the workflow engine performing operations comprising:
requiring one or more approvers indicated by the selected approval path to invoke a computer-driven analysis to determine whether fulfilling the request as received from the requester or modified or proposed by the approver would violate predetermined guidelines as to segregation of duties, regulatory compliance, or audit rules.

14. The method of claim 1, further comprising in one or more of the stages, additional operations comprising:
computer-driven equipment analyzing the request as received from the requester or modified or proposed by the approver to determine if fulfillment thereof would violate predetermined guidelines as to segregation of duties, regulatory compliance, or audit rules;
responsive to a violation, blocking amendment of the rules according to the request as analyzed.

15. The method of claim 1, further comprising in one or more of the stages, the workflow engine performing operations comprising:
requiring one or more approvers indicated by the selected approval path to invoke at least one of the following computer-driven processes:
assigning a predefined role, removing a predefined role, defining and assigning a new role.

16. The method of claim 1, further comprising at least one of the following:
computer-driven operations of identifying rule changes appropriate to the request, and proposing the identified rule changes to one or more approvers indicated by the selected approval path;
computer-driven operations of identifying rule changes appropriate to the request, and filtering potential rule changes of the one or more approvers indicated by the selected approval path to exclude inappropriate rule changes.

17. The method of claim 1, further comprising at least one of the following:
responsive to designation of one or more predefined roles by an approver indicated by the selected approval path or by the request, computer-driven operations of identifying and suggesting assignment of one or more additional roles.

18. The method of claim 1, further comprising in one or more of the stages, the workflow engine making available to approvers indicated by the selected approval path a computer-driven mitigation process including developing measures to mitigate targeted properties of the request as received from the requester or modified or proposed by the approver, where said targeted properties present a risk of violating predetermined guidelines as to segregation of duties, regulatory compliance, or audit rules.

19. The method of claim 1, where the request to change the rules comprises one of the following:
a user-initiated request to change the rules comprising submission of a user-completed electronic form;
a machine-initiated request to change the rules comprising machine generation of the electronic form.

20.-21. (canceled)

22. The method of claim 1, where the rules define users' permissions for user-initiated tasks including opening door locks, deactivating alarm systems, and granting and revoking access to physical areas.

23. One or more computer readable storage media tangibly embodying a program of machine-readable instructions executable by a digital processing apparatus to perform operations, applied in a system where a computer-driven resource manager selectively executes user-initiated tasks according to established rules defining users' permissions for such tasks, said operations managing redefinition of the rules and comprising:
a computer-driven workflow engine receiving a request to change the rules, the request comprising submission of a completed predefined electronic form by a requester;
responsive to receiving the request, the workflow engine processing the request by performing operations comprising:
reviewing data in the completed electronic form and selecting a corresponding one of multiple predefined approval paths;
in an order prescribed by the selected path, performing operations comprising:
sequentially proceeding through a sequence of one or more stages defined by the selected approval path, where in each stage the workflow engine electronically solicits approvals from one or more approvers indicated by the selected approval path;
continuing through the stages until the workflow engine receives a completion event comprising one of the following: at least one denial, or all approvals required by the selected approval path;
responsive to receiving all approvals required by the selected approval path, transmitting an electronic message directing amendment of the rules according to the request.

24. (canceled)

25. One or more computer readable storage media tangibly embodying a program of machine-readable instructions executable by a digital processing apparatus to perform operations, applied in a system where a computer-driven ERP authority selectively executes user-initiated tasks according to established roles defining users' permissions to initiate such tasks, said operations comprising:
storing a list of predefined workflows, each workflow defining a progression of mandatory actions for processing a given user request to change one or more existing roles or add one or more new roles, the progression including a prescribed order of the actions including actions performed by one or more approvers designated in the workflow, the actions selected from a group including: approval of a user requested role change or addition, modification of a user requested role change or addition, designation of a role to suit the user request;
storing one or more maps relating the workflows to various predefined sets of characteristics of possible user requests to change the roles;
responsive to user request to change a role, applying the map to the user request to identify a corresponding workflow, and thereafter proceeding in the prescribed order to notify and obtain performance of the actions by designated approvers of the identified workflow, and only upon successful completion of the identified workflow, permitting implementation of change to the roles as stated in the user request or modified or initiated by an approver by the approver.

26. The media of claim 25, where the mandatory actions further include one or more of the approvers conducting risk analysis to determine whether a proposed change in the roles would violate predetermined guidelines as to segregation of duties, regulatory compliance, or audit rules.

27. The media of claim 25, where one or more of the workflows include multiple stages and alternate paths, where one alternate paths or another is automatically determined according to results from earlier stages.

28. The media of claim 25, where the group of actions further includes dynamic changes to the workflow including:
a given approver re-routing the order to another for specified work and then back to the given approver after completion of the specified work;
a given approver declining to act and instead substituting another approver.

29. In a system where a computer-driven resource manager selectively executes user-initiated tasks according to established rules defining users' permissions for such tasks, an apparatus for managing redefinition of the rules, comprising:
a set of multiple predefined approval paths;
a computer-driven workflow engine programmed to perform operations comprising, responsive to receiving a request to change the rules, the request comprising submission of a completed predefined electronic form by a requester, processing the request by performing operations comprising:
reviewing data in the completed electronic form and selecting a corresponding one of multiple predefined approval paths;
in an order prescribed by the selected path, performing operations comprising:
sequentially proceeding through a sequence of one or more stages defined by the selected approval path, where in each stage the workflow engine electronically solicits approvals from one or more approvers indicated by the selected approval path;
continuing through the stages until the workflow engine receives a completion event comprising one of the following: at least one denial, or all approvals required by the selected approval path;
responsive to receiving all approvals required by the selected approval path, transmitting an electronic message directing amendment of the rules according to the request.

30. In a system where a computer-driven resource manager selectively executes user-initiated tasks according to established rules defining users' permissions for such tasks, an apparatus for managing redefinition of the rules, comprising:
a set of multiple predefined approval paths;
workflow engine means for performing operations comprising, responsive to receiving a request to change the rules, the request comprising submission of a completed predefined electronic form by a requestor, processing the request by performing operations comprising:
reviewing data in the completed electronic form and selecting a corresponding one of multiple predefined approval paths;
in an order prescribed by the selected path, performing operations comprising:
sequentially proceeding through a sequence of one or more stages defined by the selected approval path, where in each stage the workflow engine electronically solicits approvals from one or more approvers indicated by the selected approval path;
continuing through the stages until the workflow engine receives a completion event comprising one of the following: at least one denial, or all approvals required by the selected approval path;
responsive to receiving all approvals required by the selected approval path, transmitting an electronic message directing amendment of the rules according to the request.
